(19) United States
(12) Patent Application Publication
(10) Pub. No.: US 2026/0311452 A1
(43) Pub. Date: Oct. 8, 2026

(54) Item Identification Through Vision Language Model

(71) Applicant: Maplebear Inc., San Francisco, CA (US)

(72) Inventors: Aomin Wu, Scarsdale, NY (US); Michael Dohyun Kim, Rowland Heights, CA (US)

(21) Appl. No.: 19/098,738

(22) Filed: Apr. 2, 2025

(51) Int. Cl. G06V 10/764; B62B 3/14; B62B 5/00; G06Q 30/0601

(52) U.S. Cl. CPC G06V 10/764; B62B 3/1424; B62B 5/0096; G06Q 30/0641

(57) ABSTRACT

A smart cart system uses a vision language model (VLM) to identify items added to its storage area. The system captures sensor data from various sensors, such as load sensors and cameras, to detect actions like adding, removing, or shifting items. When an item is added, the system computes the item's load and filters candidate items from a database based on this load. The smart cart system uses video data and the VLM to identify the added item by generating scores for each candidate item. The system may use a coarse VLM for initial scoring and a finer VLM for detailed identification. Additionally, the system can fine-tune the VLM with training data generated from scanned machine-readable labels and corresponding video data, updating the VLM's parameters through a backpropagation process.

### BACKGROUND

Item identification systems, such as those used by smart cart systems, use computer-vision techniques to identify items depicted in image data or video data captured by cameras. These systems may use machine-learning models that are trained on a broad corpus of training data to predict which items are depicted in images or video. However, verifying the performance of these models is difficult. For example, to compute metrics on the performance of an item identification model, the item identification system may reserve a substantial portion of the training data and compare the output of the item identification models to the labels in the training data. This method reduces the amount of training data that is available to actually train the item identification model, which can thereby reduce the performance of the model as compared to using all of the training data for training the model.

### SUMMARY

In accordance with one or more aspects of the disclosure, a smart cart system uses a vision language model (VLM) to identify items that are added to the storage area of a smart cart system.

To use a VLM to identify items, a smart cart system accesses sensor data captured by one or more sensors coupled to the smart cart system. For example, this sensor data may include data captured by a load sensor, a proximity sensor, an inertial measurement unit (IMU), a global navigation satellite system (GNSS) sensor, or a magnetometer. The smart cart system detects actions that occur regarding the smart cart system based on sensor data, such as adding, removing, or shifting items in the storage area of the smart cart system. In some embodiments, the smart cart system uses an action detection system, which may use a sensor fusion model to predict whether actions occur based on captured sensor data. The system also determines a timestamp of the detected action using the sensor data.

In cases where the action includes adding an item to the storage area, the smart cart system accesses load sensor data captured by a load sensor coupled to the storage area of the smart cart system and computes the item's load on the storage area based on load measurements taken before and after the action was detected. The smart cart system accesses a set of candidate items from an item database by filtering items in the item database based on the load imparted by the added item. The system accesses video data from cameras positioned to view the storage area of the smart cart system, identifies a portion of the video data corresponding to the action's timestamp, and prompts a vision language model (VLM) to identify which of the candidate items were added to the storage area of the smart cart system. For example, the VLM may generate a score for each of the candidate items, where each of the scores represent a likelihood that the corresponding candidate item was added to the storage area.

In some embodiments, the smart cart system uses a coarse VLM for initial scoring and a finer VLM for detailed identification. The coarse VLM may have fewer parameters than the finer VLM, which allows the coarse VLM to score candidate items more quickly, though less accurately, than the finer VLM. The smart cart system may use these initial scores from the coarse VLM to perform an additional filtering on the candidate items before the scoring by the finer VLM.

The smart cart system may fine-tune the VLM with additional training data using a label scanner coupled to the smart cart system. When the smart cart system detects an action, the smart cart system identifies a machine-readable label that was scanned at a timestamp near when the action was detected. The smart cart system generates a training example based on the detected action and the scanned machine-readable label. The training example includes a portion of video data captured near when the action was detected and a label with an item identifier encoded in the scanned machine-readable label. The smart cart system applies the VLM to the video data of the training example and compares the output of the VLM to the label in the training example. The smart cart system updates parameters of the VLM by applying a backpropagation process through the parameters of the VLM.

### BRIEF DESCRIPTION OF DRAWINGS

FIG. 1 illustrates an example system environment for a smart cart system, in accordance with one or more illustrative embodiments.

FIG. 2 is a flowchart for an example method of training a vision language model based on training data captured by a smart cart system, in accordance with some embodiments.

FIG. 3 is a flowchart for an example method of using a vision language model to identify items in a smart cart system, in accordance with some embodiments.

FIG. 4 illustrates an example generation of a training example for training a vision language model, in accordance with some embodiments.

FIG. 5 illustrates an example generation of an item identification prompt for a vision language model, in accordance with some embodiments.

### DETAILED DESCRIPTION

### Example System Environment for Smart Cart System

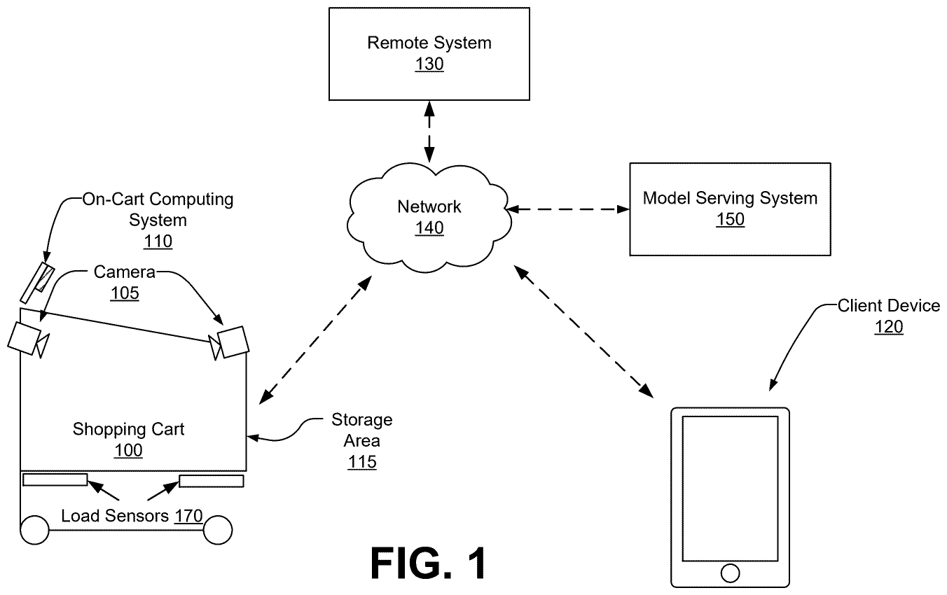

FIG. 1 illustrates an example system environment for a smart cart system, in accordance with one or more illustrative embodiments. The system environment illustrated in FIG. 1 includes a shopping cart 100, a client device 120, a remote system 130, a network 140, and a model serving system 150. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Furthermore, while the model serving system 150 is depicted as separate from the shopping cart 100 or the remote system 130, the model serving system 150 may, in some embodiments, be part of the shopping cart 100 or the remote system 130. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and capture and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves-the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include a triggering mechanism, for example a light sensor, an accelerometer, or another sensor to determine that the user is about to add an item to the shopping cart 100 or about to remove an item from the shopping cart 100. The triggering mechanism may cause the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0°when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 may allow a customer at a brick-and-mortar store to complete a checkout process in which items are scanned and paid for without having to go through a human cashier at a point-of-sale station. The on-cart computing system 110 may receive data describing a user's shopping trip in a store and generate a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera 105 of the shopping cart to identify items based on the barcodes that are visible to or captured by the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system 110 also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system110 may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system 110 uses an item lookup table to identify items depicted in an image based on OCR text extracted from that image. The item lookup table stores a set of items that may be depicted in images captured by the cameras 105 and corresponding text that is associated with each of the items. The on-cart computing system 110 stores the item lookup table for use in identifying items. For example, the on-cart computing system 110 may compare OCR text from an image to the corresponding text for each of the items to identify items depicted in images. The on-cart computing system 110 may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system 110 may generate an embedding for OCR text and compare that embedding to the embeddings stored in the item lookup table to identify the item.

Furthermore, the on-cart computing system 110 may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system 110 may store embeddings that correspond to items that a user may place in the shopping cart. Each item may be associated with a single embedding or multiple embeddings. The on-cart computing system 110 applies the image embedding model to images captured by the cameras and compares the generated embeddings to stored embeddings for items. The on-cart computing system 110 identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system 110 may receive item recommendations, recipe recommendations, or brand recommendations from the remote system 130.

The on-cart computing system 110 may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s) 105, and the sensors 170 of the shopping cart 100 are separately mounted to the shopping cart 100. Alternatively, the on-cart computing system 110, camera(s) 105, and sensors 170 may be contained within a single casing that is mounted to the shopping cart 100. This single casing may contain all of the components needed by the on-cart computing system 110 to perform the functionalities described herein. The single casing may be permanently mounted to the shopping cart 100 or may be configured to be easily attached to or detached from the shopping cart 100. This latter embodiment may enable the on-cart computing system 110 to be recharged at a separate station from the shopping cart 100 or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 may communicate with the on-cart computing system 110 of the shopping cart 100 to provide an automated checkout experience for the user. The remote system 130 may facilitate the user's payment for the items in the shopping cart 100. For example, the remote system 130 may receive the user's shopping list from the shopping cart 100 and charge the user for the cost of the items in the cart. The remote system 130 may communicate with other systems to execute the transaction, such as a computing system of the retailer or of a financial institution. The remote system 130 may receive payment information from the shopping cart 100 and use that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time (e.g., based on near-field or other communication), and thus may determine that the user associated with the client device 120 is using the shopping cart 100.

The remote system 130 may also provide content to the on-cart computing system 110 to display to the user while the user is operating the shopping cart 100. For example, the remote system 130 may use stored user data associated with the user of the shopping cart 100 to select content that the user is most likely to interact with. The remote system 130 may transmit that content to the on-cart computing system 110 for display to the user. The remote system 130 may also provide other data to the on-cart computing system 110. For example, the remote system 130 may store item data describing items in the store and the remote system 130 may provide that item data to the on-cart computing system 110 for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

The model serving system 150 receives requests from the on-cart computing system 110 or the remote system 130 to perform tasks using machine-learned models. The tasks may include, but are not limited to, natural language processing (NLP) tasks, audio processing tasks, image processing tasks, video processing tasks, and the like. In one embodiment, the machine-learned models deployed by the model serving system 150 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model may be coupled to receive sequential data tokenized into a sequence of input tokens and generate a sequence of output tokens depending on the task to be performed.

The model serving system 150 may receive a request including input data (e.g., text data, audio data, image data, or video data) and encode the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the on-cart computing system 110 or the remote system 130 or one or more entities different from the on-cart computing system 110 or the remote system 130. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other arrangements, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the model serving system 150 is based on knowledge of the on-cart computing system 110 or the remote system 130 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

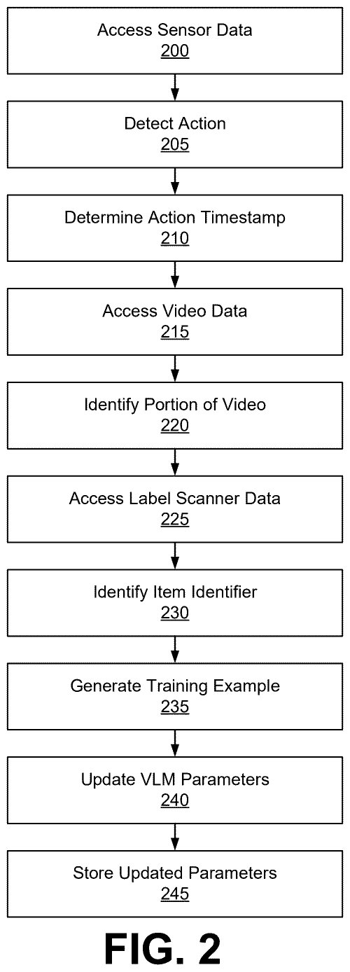

FIG. 2 is a flowchart for an example method of training a vision language model based on training data captured by a smart cart system, in accordance with some embodiments. Alternative embodiments may include more, fewer, or different steps from those illustrated in FIG. 2, and the steps may be performed in a different order from that illustrated in FIG. 2. These steps may be performed by smart cart system (e.g., shopping cart 100), by a remote system (e.g., remote system 130), or a combination of both. Additionally, each of these steps may be performed automatically by these systems without human intervention.

The smart cart system 200 accesses sensor data captured by a sensor coupled to the smart cart system. For example, the sensor data may be captured by a load sensor, a proximity sensor, an inertial measurement unit (IMU), a Global Navigation Satellite System (GNSS) sensor, or a magnetometer. In some embodiments, the sensor data includes video data captured by a camera coupled to the smart cart system. The sensor data includes a set of measurements captured by the sensor over a period of time. Each measurement may be associated with a timestamp indicating when the measurement was captured by the sensor. In some embodiments, the smart cart system may involve multiple sensors in this process.

The smart cart system detects 205 actions that occur with respect to the smart cart system based on sensor data. For example, the smart cart system may detect whether an item has been added to, removed from, or shifted around in the storage area 115 of the smart cart system. For simplicity, the description herein may primarily describe an item being added to the storage area 115. However, similar principles may be used for other kinds of actions.

The smart cart system may use an action detection system to detect actions performed by a user. For instance, the system can detect added, removed, or shifted items within the storage area. The action detection system may use a sensor fusion model to detect actions performed with respect to the smart cart system. A sensor fusion model is a machine-learning model that is trained to predict the likelihood that an action has occurred with regard to the smart cart system based on sensor data captured by the sensors coupled to the smart cart system. The action detection system may apply the sensor fusion model to sensor data captured by the smart cart system and detect that an action occurred based on sensor data captured by the smart cart system. In some embodiments, the action detection system predicts which type of action has occurred as well as whether an action occurred. U.S. patent application Ser. No. 19/069,121, entitled “Receptacle System using Real-Time Large Language Model Integration to Predict a State of the Receptacle System” and filed Mar. 3, 2025, describes an example action detection system that may be used in accordance with some embodiments and is incorporated by reference.

The smart cart system determines 210 the timestamp at which the detected action occurred based on the accessed sensor data. For example, the smart cart system may analyze the timestamps of sensor measurements used to detect the action and may predict a timestamp at which the detected action occurred based on the timestamps of the sensor measurements. In embodiments where an action detection system uses a sensor fusion model, the sensor fusion model may be further trained to predict a timestamp for the detected action.

The smart cart system accesses 215 video data captured by one or more cameras 105 coupled to the smart cart system. These cameras 105 may be positioned to have a field of view into the storage area 115 of the smart cart system or parallel to the plane of the storage area's 115 opening. The video data may include frames captured by the cameras 105 over a period of time, and each frame may be associated with a timestamp at which the frame was captured.

The smart cart system identifies 220 a portion of the video data that corresponds to the timestamp at which the action occurred. For example, the smart cart system may identify a subset of the set of frames in the video data within some timeframe around the determined timestamp at which the action detection system detected an action occurred. In some embodiments, rather than or in addition to using an action detection system to detect actions for identifying portions of the video data, the smart cart system uses a vision language model (VLM) to identify the portion of the video data directly. For example, the smart cart system may transmit a prompt to the vision language model to generate timestamps of when actions occur in a video. This prompt may include the captured video data and text instructions for the VLM to generate one or more timestamps within the video where actions occur. The smart cart system may use timestamps from the VLM to identify the portions of the video data.

The smart cart system accesses 225 label scanner data captured by a label scanner coupled to the smart cart system. This data describes machine-readable labels (e.g., barcodes or QR codes) that were scanned by the label scanner. The label scanner data may contain measurements of these machine-readable labels, and each measurement may include a timestamp indicating when the machine-readable label was scanned by the label scanner. Additionally, the label scanner data may encompass decoded information from the machine-readable labels. For example, the label scanner data may include numerical values encoded by the scanned machine-readable labels.

The smart cart system identifies 230 an item identifier for an item associated with the detected action based on the label scanner data and the determined timestamp. For example, the smart cart system may identify, in the label scanner data, a machine-readable label that was scanned in association with the detected action. The smart cart system may identify the machine-readable label by determining which of a set of scanned machine-readable labels was scanned at a time closest to the determined timestamp. The smart cart system may decode the information from the identified machine-readable label and compare the decoded information to stored item identifiers to determine which item identifier is encoded in the scanned machine-readable label.

The smart cart system 235 generates a training example for a vision language model based on the identified portion of the video data and item identifier from the machine-readable label. The training example may include input data for the vision language model and a label for the intended output. The input data may include the identified portion of the video data, while the label comprises the item identifier corresponding to the identified machine-readable label. Additionally, the training example may include captured sensor data as part of the input data.

The smart cart system updates 240 a plurality of parameters of the VLM based on the generated training example and stores 245 the updated parameters of the VLM to a computer-readable medium. The smart cart system updates the VLM by applying the VLM to the input data of the training example to generate an output. For example, the VLM may generate a predicted item identifier based on the portion of the video data in the training example. The smart cart system compares that output of the VLM with the label of the training example to update the parameters. In some embodiments, the smart cart system computes a loss score by applying a loss function to the output of the VLM and to the label. The smart cart system may update the parameters using a backpropagation process based on the computed loss score.

The smart cart system may generate multiple training examples using the process above and train the VLM based on each of the training examples. Furthermore, the VLM may be trained based on training examples generated by multiple smart cart systems. Furthermore, the VLM may be trained based on training examples other than those generated through the process above. For example, the VLM may be initially trained on a broader corpus of training data and the process above may be used to “fine tune” the VLM to the particular purpose of identifying items for a smart cart system.

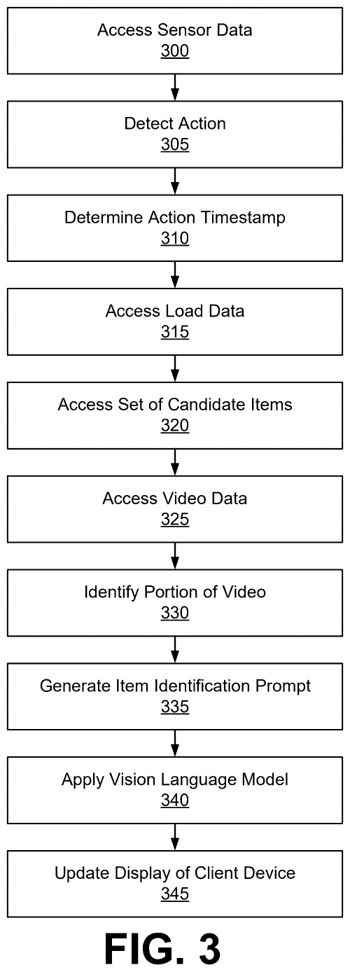

FIG. 3 is a flowchart for an example method of using a vision language model to identify items in a smart cart system, in accordance with some embodiments. Alternative embodiments may include more, fewer, or different steps from those illustrated in FIG. 3, and the steps may be performed in a different order from that illustrated in FIG. 3. These steps may be performed by smart cart system (e.g., shopping cart 100), by a remote system (e.g., remote system 130), or a combination of both. Additionally, each of these steps may be performed automatically by these systems without human intervention.

The smart cart system 300 accesses sensor data captured by a sensor coupled to the smart cart system. For example, the sensor data may be captured by a load sensor, a proximity sensor, an inertial measurement unit (IMU), a Global Navigation Satellite System (GNSS) sensor, or a magnetometer. In some embodiments, the sensor data includes video data captured by a camera 105 coupled to the smart cart system. The sensor data includes a set of measurements captured by the sensor over a period of time. Each measurement may be associated with a timestamp indicating when the was captured by the sensor. In some embodiments, the smart cart system may involve multiple sensors in this process.

The smart cart system detects 305 actions that occur with respect to the smart cart system based on sensor data. For example, the smart cart system may detect whether an item has been added to, removed from, or shifted around in the storage area 115 of the smart cart system. For simplicity, the description herein may primarily describe an item being added to the storage area 115. However, similar principles may be used for other kinds of actions.

The smart cart system may use an action detection system to detect actions performed by a user. For instance, the system can detect added, removed, or shifted items within the storage area 115. The action detection system may use a sensor fusion model to detect actions performed with respect to the smart cart system. A sensor fusion model is a machine-learning model that is trained to predict the likelihood that an action has occurred with regard to the smart cart system based on sensor data captured by the sensors coupled to the smart cart system. The action detection system may apply the sensor fusion model to sensor data captured by the smart cart system and detect that an action occurred based on sensor data captured by the smart cart system. In some embodiments, the action detection system predicts which type of action has occurred as well as whether an action occurred. U.S. patent application Ser. No. 19/069,121, entitled “Receptacle System using Real-Time Large Language Model Integration to Predict a State of the Receptacle System” and filed Mar. 3, 2025, describes an example action detection system that may be used in accordance with some embodiments and is incorporated by reference.

The smart cart system determines 310 the timestamp at which the detected action occurred based on the accessed sensor data. For example, the smart cart system may use the timestamps of sensor measurements used to detect the action to predict a timestamp at which the detected action occurred based on the timestamps of the sensor measurements. In embodiments where an action detection system uses a sensor fusion model, the sensor fusion model may be further trained to predict a timestamp for the detected action.

The smart cart system accesses 315 load sensor data captured by a load sensor 170 coupled to the smart cart system. The load sensor 170 may continually capture load measurements over time, and may capture a first load imparted on the storage area 115 before the item was added and a second load imparted on the storage area 115 after the item was added. The smart cart system may compute a difference between the first and second load to represent the load imparted by the item added to the storage area 115.

The smart cart system accesses 320 a set of candidate items stored in an item database. The item database stores item data for a set of items that are available in the store where the cart system operates. Each entry in the item database stores item data for a corresponding item. For example, the entries in the item database may include weight data describing a weight for an item. The smart cart system may filter the set of items in the item database to identify a set of candidate items. For example, the smart cart system may filter the items in the item database based on the load imparted by the item. To filter based on the item's weight, the smart cart system may identify items with weight data within a threshold difference from the computed load imparted by the added item. In some embodiments, to identify when the user adds more than one of the same item into the storage area 115, the smart cart system filters candidate items where integer multiples of their weights are within a threshold difference from the computed load.

The smart cart system accesses 325 video data captured by one or more cameras 105 coupled to the smart cart system. These cameras 105 may be positioned to have a field of view into the storage area 115 of the smart cart system or parallel to the plane of the storage area's opening. The video data includes frames captured by the cameras 105 over a period of time, and each frame is associated with a timestamp at which the frame was captured.

The smart cart system identifies 330 a portion of the video data that corresponds to the timestamp at which the action occurred. For example, the smart cart system may identify a subset of the set of frames in the video data within some timeframe around the determined timestamp at which the action detection system detected an action occurred. In some embodiments, rather than or in addition to using an action detection system to detect actions for identifying portions of the video data, the smart cart system uses a vision language model (VLM) to identify the portion of the video data directly. For example, the smart cart system may transmit a prompt to the vision language model to generate timestamps of when actions occur in a video. This prompt may include the captured video data and text instructions for the VLM to generate one or more timestamps within the video where actions occur. The smart cart system may use timestamps from the VLM to identify the portions of the video data.

The smart cart system generates 335 an item identification prompt for a VLM. The item identification prompt is a prompt to the VLM to identify items depicted in a video. The item identification prompt includes the identified portion of the video data and the accessed set of candidate items. The item identification prompt also includes text instructions for the VLM to identify the item added to the storage area 115 of the smart cart system from one of the included set of candidate items. For example, the text instructions may direct the VLM to generate a score for each candidate item representing a likelihood that the corresponding candidate item is the one that was added to the smart cart system. In some embodiments, the item identification prompt includes the accessed sensor data and includes text instructions for the VLM to use the sensor data to identify the item added to the smart cart storage area 115.

The smart cart system applies 340 the VLM to the item identification prompt to generate an output. The output from the VLM includes a prediction for the item identifier for the item added to the smart cart system. For example, the VLM may output a score for each of the candidate items indicating a likelihood that the corresponding candidate item was added to the smart cart system. In some embodiments, the VLM has been fine-tuned using the method described above with regard to FIG. 2.

In some embodiments, the smart cart system first prompts a coarse VLM to perform an initial scoring of the set of candidate items and filters the set of candidate items based on the scores generated by the coarse VLM. The smart cart system uses this filtered set of candidate items for another item identification prompt to a finer VLM. The coarse VLM may have fewer parameters than the fine VLM, which makes the coarse VLM less accurate than the fine VLM but means that the coarse VLM executes more quickly than the fine VLM. Thus, the smart cart system may filter out candidate items with initial scores from the coarse VLM from the item identification prompt to the fine VLM. The coarse VLM and the fine VLM may be trained based on the method described above with regard to FIG. 2.

The smart cart system updates 345 a display of a client device based on the predicted item identifier generated by the VLM. For example, the smart cart system may update a display on the smart cart system to include content related to the item identifier. Similarly, the smart cart system may update a display of a mobile device or computer associated with an operator of the smart cart system to include content associated with the item identifier. For example, the VLM may be used as part of an auditing system to ensure that users are not defrauding the smart cart system. If the VLM identifies a different item added to the storage area than the user paid for, then the auditing system may determine that the item was incorrectly identified and an operator of the smart cart system may be notified through a display of a client device.

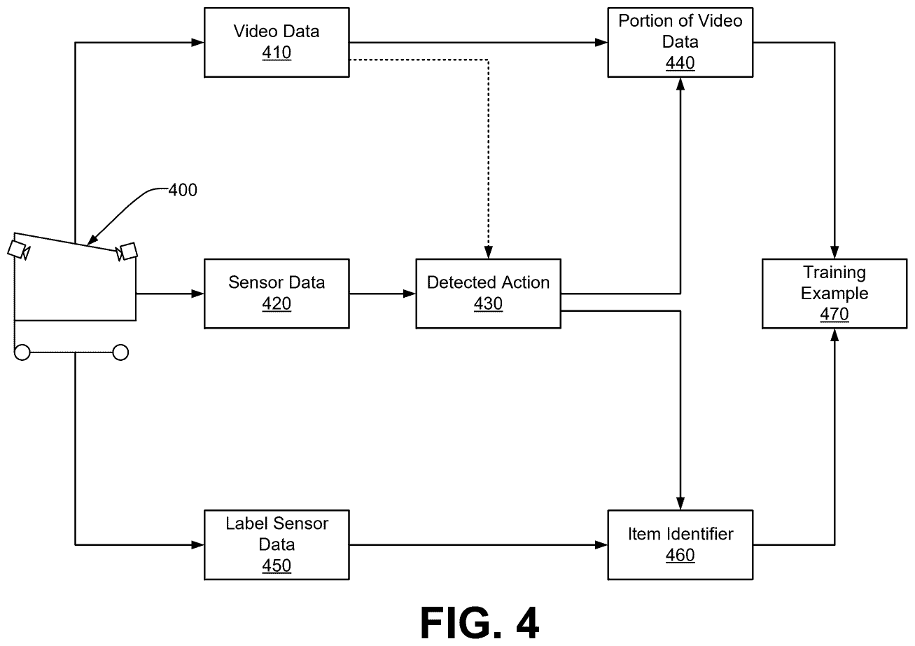

FIG. 4 illustrates an example generation of a training example for training a vision language model, in accordance with some embodiments. The smart cart system 400 may generate video data 410 from cameras 105 coupled to the smart cart system and generate sensor data 420 from sensors 170 coupled to the smart cart system. The smart cart system may detect that an action 430 occurs where an item is added to the storage area 115 of the smart cart system based on the sensor data. As noted above, in some embodiments, the video data is used to detect the action. The smart cart system may use the detected action to identify a portion 440 of the video data in which the action is depicted (e.g., where the item is added to the storage area 115).

The smart cart system also may generate label sensor data 450 from a label sensor coupled to the smart cart system. The smart cart system may use the detected action to identify the machine-readable label that corresponds to the detected action, and the smart cart system may determine the item identifier 460 that was encoded by the machine-readable label. The smart cart system may generate a training example 470 based on the portion of the video data and the item identifier.

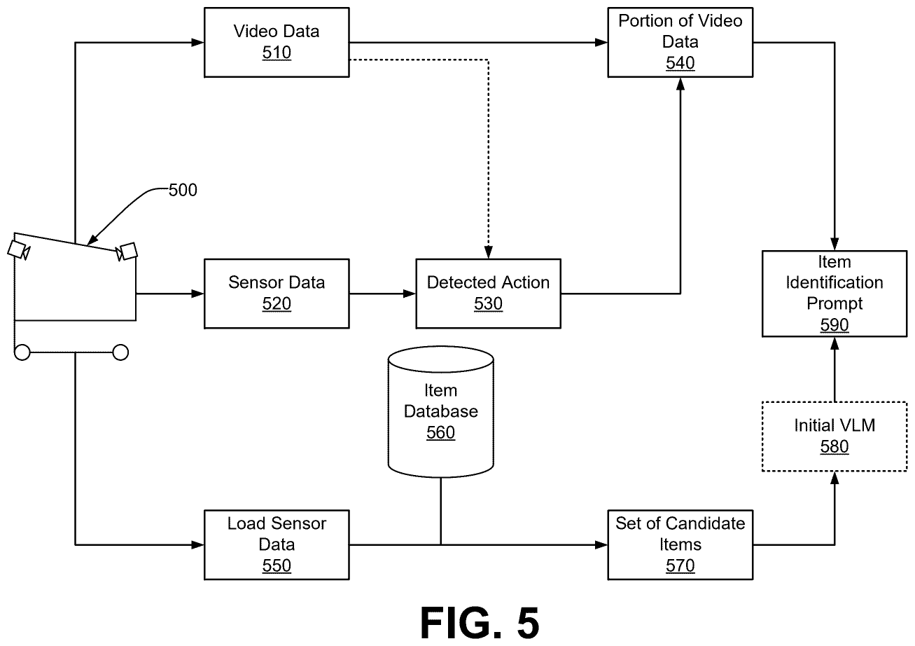

FIG. 5 illustrates an example generation of an item identification prompt for a vision language model, in accordance with some embodiments. The smart cart system 500 may generate video data 510 from cameras 105 coupled to the smart cart system and generate sensor data 520 from sensors coupled to the smart cart system. The smart cart system may detect that an action 530 occurs where an item is added to the storage area 115 of the smart cart system based on the sensor data. As noted above, in some embodiments, the video data is used to detect the action. The smart cart system may use the detected action to identify a portion 540 of the video data in which the action is depicted (e.g., where the item is added to the storage area).

The smart cart system also may generate load sensor data 550 from a load sensor 170 coupled to the storage area 115 of the smart cart system. The smart cart system may use the load sensor data to determine a load imparted on the storage area by an added item and use the determined load to filter entries in an item database 560 to identify a set of candidate items 570. As described above, in some embodiments, the smart cart system may use an initial VLM 580 to further filter the set of candidate items, where the initial VLM has fewer parameters than the final VLM. The smart cart system may generate an item identification prompt 590 with the portion of the video data 540 and the set of candidate items 570.

### OTHER CONSIDERATIONS

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method, performed at a computer system comprising a processor and a non-transitory computer-readable medium, comprising:
accessing sensor data captured by a sensor coupled to a smart cart system;
detecting, based on the sensor data, that an action has occurred with respect to the smart cart system, wherein the action comprises an item being added to a storage area of the smart cart system by a user;
determining a timestamp at which the action occurred based on the sensor data;
accessing load sensor data captured by a load sensor coupled to the smart cart system, wherein the load sensor data describes a first load imparted on the storage area before the item was added and a second load imparted on the storage area after the item was added;
accessing a set of candidate items stored in a candidate item database, wherein accessing the set of candidate items comprises filtering candidate item entries in the candidate item database based on a difference between the first load and the second load;
accessing video data captured by a camera coupled to the smart cart system;
identifying a portion of the video data that corresponds to the timestamp at which the action occurred;
generating an item identification prompt for a vision language model, wherein the item identification prompt comprises the identified portion of the video data, the set of candidate items, and text instructions for the vision language model to identify the item added to the storage area of the smart cart system;
applying the vision language model to the item identification prompt to generate an output, wherein the output comprises a prediction for an item identifier for the item added to the storage area; and
updating a display of a client device to include content related to the item associated with the item identifier output by the vision language model.

2. The method of claim 1, wherein the sensor data comprises proximity sensor data, inertial measurement unit data, GNSS sensor data, or magnetometer data.

3. The method of claim 1, wherein detecting that an action occurred comprises:
detecting that an action occurred based on the accessed load sensor data.

4. The method of claim 1, wherein detecting that an action occurred comprises:
applying a sensor fusion model to the accessed sensor data, wherein the sensor fusion model is a machine-learning model trained to predict a likelihood that an action has occurred based on sensor data.

5. The method of claim 4, wherein the sensor fusion model is further trained to predict a timestamp at which the action occurred, and wherein identifying the timestamp at which the action occurred comprises:
determining the timestamp based on a predicted timestamp output by the sensor fusion model.

6. The method of claim 1, wherein identifying the portion of the video data that corresponds to the timestamp at which the action occurred comprises:
applying the vision language model to the accessed video data with text instructions to identify portions of the video data where actions occur.

7. The method of claim 1, wherein identifying the portion of the video data comprises:
identifying a portion of the video data captured within a timeframe around the determined timestamp.

8. The method of claim 1, wherein the output of the vision language model comprises a score for each candidate item of the set of candidate items, wherein the score represents a likelihood that the corresponding candidate item was the item added to the storage area of the smart cart system.

9. The method of claim 1, further comprising:
generating an initial item identification prompt for an initial vision language model, wherein the initial item identification prompt comprises the identified portion of the video data, an initial set of candidate items, and text instructions for the initial vision language model to identify the item added to the storage area of the smart cart system;
applying the initial vision language model to the initial item identification prompt to generate an output, wherein the initial vision language model comprises fewer parameters than the vision language model, and wherein the output comprises a score for each of the initial set of items representing a likelihood that the corresponding candidate item was the added item; and
generating the set of candidate items based on the output of the initial vision language model.

10. The method of claim 1, wherein applying the vision language model comprises:
transmitting a prompt to a model serving system executing the vision language model.

11. A non-transitory computer-readable medium storing instructions that, when executed by a computing system, cause the computing system to perform operations comprising:
accessing sensor data captured by a sensor coupled to a smart cart system;
detecting, based on the sensor data, that an action has occurred with respect to the smart cart system, wherein the action comprises an item being added to a storage area of the smart cart system by a user;
determining a timestamp at which the action occurred based on the sensor data;
accessing load sensor data captured by a load sensor coupled to the smart cart system, wherein the load sensor data describes a first load imparted on the storage area before the item was added and a second load imparted on the storage area after the item was added;
accessing a set of candidate items stored in a candidate item database, wherein accessing the set of candidate items comprises filtering candidate item entries in the candidate item database based on a difference between the first load and the second load;
accessing video data captured by a camera coupled to the smart cart system;
identifying a portion of the video data that corresponds to the timestamp at which the action occurred;
generating an item identification prompt for a vision language model, wherein the item identification prompt comprises the identified portion of the video data, the set of candidate items, and text instructions for the vision language model to identify the item added to the storage area of the smart cart system;
applying the vision language model to the item identification prompt to generate an output, wherein the output comprises a prediction for an item identifier for the item added to the storage area; and
updating a display of a client device to include content related to the item associated with the item identifier output by the vision language model.

12. The computer-readable medium of claim 11, wherein the sensor data comprises proximity sensor data, inertial measurement unit data, GNSS sensor data, or magnetometer data.

13. The computer-readable medium of claim 11, wherein detecting that an action occurred comprises:
detecting that an action occurred based on the accessed load sensor data.

14. The computer-readable medium of claim 11, wherein detecting that an action occurred comprises:
applying a sensor fusion model to the accessed sensor data, wherein the sensor fusion model is a machine-learning model trained to predict a likelihood that an action has occurred based on sensor data.

15. The computer-readable medium of claim 14, wherein the sensor fusion model is further trained to predict a timestamp at which the action occurred, and wherein identifying the timestamp at which the action occurred comprises:
determining the timestamp based on a predicted timestamp output by the sensor fusion model.

16. The computer-readable medium of claim 11, wherein identifying the portion of the video data that corresponds to the timestamp at which the action occurred comprises:
applying the vision language model to the accessed video data with text instructions to identify portions of the video data where actions occur.

17. The computer-readable medium of claim 11, wherein identifying the portion of the video data comprises:
identifying a portion of the video data captured within a timeframe around the determined timestamp.

18. The computer-readable medium of claim 11, wherein the output of the vision language model comprises a score for each candidate item of the set of candidate items, wherein the score represents a likelihood that the corresponding candidate item was the item added to the storage area of the smart cart system.

19. The computer-readable medium of claim 11, further comprising:
generating an initial item identification prompt for an initial vision language model, wherein the initial item identification prompt comprises the identified portion of the video data, an initial set of candidate items, and text instructions for the initial vision language model to identify the item added to the storage area of the smart cart system;
applying the initial vision language model to the initial item identification prompt to generate an output, wherein the initial vision language model comprises fewer parameters than the vision language model, and wherein the output comprises a score for each of the initial set of items representing a likelihood that the corresponding candidate item was the added item; and
generating the set of candidate items based on the output of the initial vision language model.

20. A system comprising:
a processor; and
a non-transitory computer-readable medium storing instructions that, when executed by a computing system, cause the computing system to perform operations comprising:
accessing sensor data captured by a sensor coupled to a smart cart system;
detecting, based on the sensor data, that an action has occurred with respect to the smart cart system, wherein the action comprises an item being added to a storage area of the smart cart system by a user;
determining a timestamp at which the action occurred based on the sensor data;
accessing load sensor data captured by a load sensor coupled to the smart cart system, wherein the load sensor data describes a first load imparted on the storage area before the item was added and a second load imparted on the storage area after the item was added;
accessing a set of candidate items stored in a candidate item database, wherein accessing the set of candidate items comprises filtering candidate item entries in the candidate item database based on a difference between the first load and the second load;
accessing video data captured by a camera coupled to the smart cart system;
identifying a portion of the video data that corresponds to the timestamp at which the action occurred;
generating an item identification prompt for a vision language model, wherein the item identification prompt comprises the identified portion of the video data, the set of candidate items, and text instructions for the vision language model to identify the item added to the storage area of the smart cart system;
applying the vision language model to the item identification prompt to generate an output, wherein the output comprises a prediction for an item identifier for the item added to the storage area; and
updating a display of a client device to include content related to the item associated with the item identifier output by the vision language model.
